(19) United States
(12) Patent Application Publication
(10) Pub. No.: US 2025/0186815 A1
(43) Pub. Date: Jun. 12, 2025

(54) FLEXIBLE HEAT BARRIER AND FIRE SHELTER FOR WILDLAND FIREFIGHTERS MADE THEREFROM

(71) Applicant: Sundance Management LLC, Sheridan, WY (US)

(72) Inventor: Stephen D. Miller, Flagstaff, AZ (US)

(21) Appl. No.: 19/057,640

(22) Filed: Feb. 19, 2025

Related U.S. Application Data
(63) Continuation-in-part of application No. 18/094,881, filed on Jan. 9, 2023.
Application No. 18/094,881 is a continuation-in-part of application No. 17/916,794, filed on Oct. 3, 2022.
Application No. 18/094,881 is a continuation-in-part of application No. 17/572,619, filed on Jan. 10, 2022.
Application No. 17/572,619 is a continuation-in-part of application No. PCT/US23/10428, filed on Jan. 9, 2023.
(60) Provisional application No. 63/298,168, filed on Jan. 10, 2022.
(60) Provisional application No. 63/134,977, filed on Jan. 8, 2021.
(60) Provisional application No. 63/134,975, filed on Jan. 8, 2021.

(51) Int. Cl. A62C 2/10

(52) U.S. Cl. CPC A62C 2/10

(57) ABSTRACT

A flexible heat barrier is configured to absorb and deflect heat energy and utilizes a multilayer construction wherein each layer provides a specific purpose. An outer layer configured for exposure to a heat flux includes a coating having an intumescent component and an opacifier component. An inner layer includes a foil that may include a high emittance coating to more effectively reflect radiation. A middle layer includes a insulating fabric layer that may include oriented fibers that can effectively polarize radiation and may include a plurality of layers of oriented fibers that are configured at an offset angle to deflect and reduce radiation transmission through the middle layer. A flexible heat barrier may also include a flexible gas barrier that includes a phase change material, such as frits that melt at a predetermined temperature and flow into gaps to reduce the permeability and further block heat flux.

### CROSS REFERENCE TO RELATED APPLICATIONS

This application is a continuation in part application of U.S. application Ser. No. 18/094,881, filed on Jan. 9, 2023 and currently pending, which is a continuation in part application of U.S. application Ser. No. 17/916,794, filed on Oct. 3, 2022 and currently pending, which is a national stage application of PCT application No. PCT/US22/11870, filed on Jan. 10, 2022, which claims the benefit of priority to U.S. provisional patent application No. 63/298, 168, filed Jan. 10, 2022, provisional patent application No. 63/134,977, filed on Jan. 8, 2021, and provisional patent application No. 63/134,975, filed on Jan. 8, 2021, and this application is a continuation in part of U.S. patent application Ser. No. 17/572,619 filed on Jan. 10, 2022 and currently pending, and this is a continuation in part of PCT application No. PCT/US23/10428, filed on Jan. 9, 2023; the entirety of all applications are hereby incorporated by reference herein.

### BACKGROUND OF THE INVENTION

### Field of the Invention

The invention relates to a flexible polarizing heat barrier and method of blocking heat therewith, wherein the heat barrier is flexible polarizing heat barrier optimized for minimal weight and thickness, and maximal effectiveness as a thermal barrier by use of the optical properties of the fibers therein, and applications of said flexible polarizing heat barrier including fire shelters for wildland firefighters and aerospace entry vehicle shields.

### Background

Wildland firefighters are on the front line of fighting wildfires. They cut and remove burning material to slow or stop the fire and conduct backburning for the same purpose. Unfortunately, these firefighters sometimes are overtaken by a fast moving wildfire, such as when the wind changes direction. When they are trapped and can not escape from the approaching fire, their last resort is to deploy a fire shelter and take cover within the shelter. Efforts have been made to make these portable and emergency fire shelters lighter in weight, smaller in volume and more capable of deflecting flame fronts and high temperatures.

The frequency and intensity of these emergency fire fighter situations where a fire shelter is required is increasing due to climate change, which is causing drier conditions that drive hotter fires that are more difficult to control. Wildland firefighters are needed to save civilian lives, protect structures, and safeguard national treasures like the General Sherman Tree in Sequoia National Park. Firefighters carry a fire shelter to protect themselves if they are trapped by a burning fire, but the efficacy of the shelter is limited by the amount of gear the firefighters carry. Although different types of firefighters carry different amounts of gear, Hot Shots, for example, often hike long distances, work long shifts, and often carry more than 20.4 kg (45 lbs). including the fire shelter. A heavier/bulkier fire shelter would provide better protection but would also impede their ability to do their job and increase fatigue, which could ultimately endanger more firefighters.

The M2002 fire shelter, available from the U.S. Forest Service weighs 2.0 kg (4.4 lbs), occupies 3.44 kcm³ (210 in³) and provides approximately 54 seconds of protection in simulated fire exposures. The design replaced a single wall fire shelter that was developed in the 1970's, which provided approximately 15 seconds of protection. The current M2002 fire shelter prevents serious injury or death approximately 90% of the times it is deployed.

The M2002 fire shelter met all the original criteria set by the U.S. Forest Service and included a multilayer construction, including an outer layer made of woven silica cloth laminated to 1.0 mil aluminum foil, referred to as the outer layer. The foil on the outside reflects radiant heat and absorbs heat when it finally melts as the flames reach the shelter. The adhesive that holds the foil to the fabric decomposes without adding heat or toxic gasses. The silica fabric slows the rate of heat transfer to the inside of the shelter, as does the small gap between the outer layer and inner layer. The inner layer is made of a lightweight, fiberglass fabric laminated to aluminum foil. In this layer, the foil faces the inside of the shelter such that as the temperature of the inner surface increases, less heat is radiated within the shelter to heat the occupant. The foil also provides a barrier to keep flammable gasses, toxic fumes and/or smoke from contaminating the breathing air of the shelter occupant. The new design also includes a floor to provide structural integrity and seal out smoke, seams that are designed to stiffen the shelter structure such that it will maintain its shape even after the foil burns off the outer layer, and special handles on the long side of the shelter such that the shelter can be quickly deployed with a few ‘shakes’. The M2002 fire shelter was first available through General Services Administration (GSA) in June of 2003.

A portable fire shelter that has improved heat barrier properties and/or reduced weight would be of great value to the U.S. Forest Service to protect our wildfire firefighters.

### SUMMARY OF THE INVENTION

The invention is directed to a flexible polarizing heat barrier configured to absorb and deflect heat energy and applications thereof, including fire shelters for wildland firefighters and heat shield for aerospace entry vehicles. The improved portable fire shelter utilizes new materials that enable improved fire, flame, radiant heat and temperature protection at a lower weight.

A flexible polarizing heat barrier may include a plurality of layers, each with a specific purpose and configuration with respect to the heat or flame exposure. An insulating fabric layer may be configured between an outer coating and an inner foil component. The fabric layer may include high temperature fibers woven to reduce hot gas flow into the surface and/or as an opacifier to attenuate radiative heat transfer in addition to satisfying mechanical requirements. The fibers of the insulating fabric layer may be oriented to provide polarization of the radiant energy. A coating may be coupled to the insulating fabric layer and extend on an exposure side of the flexible polarizing heat barrier. The coating may include a particular arrangement of materials to reduce the permeability of the flexible polarizing heat barrier, provide heat capacitance and deflect or reflect heat from the flexible polarizing heat barrier. A foil may be coupled to the insulating fabric and may form the shield side of the flexible polarizing heat barrier, or inner layer when formed into a portable fire shelter.

A flexible polarizing heat barrier may include a coating that may be coupled to the insulating fabric layer and configured as the exposed layer (exposed to flames, high winds, abrasion, etc.) of the flexible polarizing heat barrier, configured for exposure to the incident heat. Alternatively, the coating may be configured as an element within a Thermal Protection System that includes other elements designed to provide other specific benefits not covered herein. The coating may be configured for absorbing and deflecting heat and reducing airflow through the flexible polarizing heat barrier. An exemplary coating may include an intumescent component that expands with heat to increase the volume of the coating during exposure to heat and/or flame, an opacifier component, such as high temperature fibers, a gas barrier component that reduces the permeability of the flexible polarizing heat barrier and a binder to hold the various materials together and/or bond the coating to the insulating fabric layer.

A flexible polarizing heat barrier may include a metal foil that is configured opposite the coating from the insulating fabric and on a shield side of the flexible polarizing heat barrier. The shield side forms and interior side of the fire shelter, or occupant side, opposite the direction of heat source or flame. A metal foil may be titanium as it has very high temperature capability and lower density than other metals, and the foil may include a gold coating to reduce emissivity, or it may be aluminum foil with its advantages of low cost and ready availability. Aluminum has an emissivity of about 0.3 in the oxidized form at a temperature of 400° C. and gold has an emissivity of about 0.01 to 0.1 at a temperature of 400° C. The gold may vapor deposited on a foil, such as aluminum or titanium and may be very thin, such as about 1,500 μm or less, or 1,000 μm or less, or 700 μm or less and any range between and including the thickness values provided. Put another way, a foil may have a first layer that has a first emissivity and a second layer that has an emissivity that is at least half the emissivity of the first layer at a temperature of 400° C. The second layer may be a vapor deposited layer on the first layer and may be very thin, having a thickness that is a fraction of the first layer thickness, such as a quarter or less, a tenth or less, a twentieth or less, a hundredth or less or less. The thickness of the second layer may be about, 500 μm or less, or 1,000 μm or less, or 700 μm or less and any range between and including the thickness values provided.

An exemplary flexible polarizing heat barrier includes each of the three layers, the insulating fabric layer with the coating configured on an exposure side and a metal foil configured on a shield side of the flexible polarizing heat barrier. Additional layers of material or components may be included in the flexible polarizing heat barrier, including:
a. a phase change material, a material that melts and flows to absorb heat and reduce permeability of the flexible polarizing heat barrier;
b. Vermiculite, a natural material that occurs in platelets which may align to reduce advection through the flexible polarizing heat barrier;
c. Opacifiers, particles or whiskers with optical properties chosen to attenuate radiative heat transfer through the flexible polarizing heat barrier; and
d. Intumescent materials, that expand and absorb heat as they are heated.

A fire shelter made with the flexible polarizing heat barrier may have improved survivability time, as described herein and may be light weight. The coating aids in deflecting and absorbing the heat and flame, while the insulating layer provides strength and can be configured with an opacifier or may polarize the radiant energy to reduce heat transmission through the flexible polarizing heat barrier. The metal foil on the shield side of the flexible polarizing heat barrier is a reflective shield component that may include materials with low emissivity to reflect radiant heat back away from the shield side.

An exemplary fire shelter may be designed with curved surfaces and minimal surface-area-to-volume ratio to reduce radiant heat absorption and avoid causing fires near deployed shelters. An exemplary fire shelter may allow the occupant to lie face-down to breathe cooler, smoke-free air. An exemplary fire shelter may utilize materials selected to optimize strength, thermal protection, radiant heat resistance, flammability resistance, toxic outgassing and combustion products and durability to folding and unfolding for deployment.

An exemplary fire shelter has an upper shell portion and a floor portion configured to extend over the ground when deployed. The upper shell portion includes a shell fabric that may be constructed using the flexible polarizing heat barrier described herein. The shell fabric may be durable and have effective strength for the portable fire shelter application, including resisting high winds that are common with approaching fires. The shell fabric may have an average burst strength, for three specimens, of not less than 482 kPa (70 psi) when tested per ASTM D 774 and Paragraph 4.4.2.7 of the United States Department of Agriculture (USDA) specification. Also, the shell fabric may have a tensile strength of about 157N/cm (90 lbf/in) or more, or about 210N/cm (120 lbf/in) or more, according to USDA Forest Service Specifications 5100-607D and tested according to ASTM D5034-21 Standard Test Method for Breaking Strength and Elongation of Textile Fabrics (Grab Test).

### INSULATING FABRIC LAYER

The flexible polarizing heat barrier includes an insulating fabric layer having an array of high temperature fibers such as those shown in Table 1. The fibers may be woven or non-woven fibers and may have a melt temperature of at least 800° C. or more, and preferably 1000° C. or more, or even 1200° C. or more. The fibers may be inorganic fibers such as silicon carbide, glass, fiberglass, quartz and the like. The fibers may also be carbon fibers. The fibers may be carbon fibers that are subsequently converted to silicon carbide in situ. The fibers may be PAN-derived carbon. The fibers may include polymeric fibers such as polyimide fibers that have a melt temperature of above 350° C. and which might aid in absorbing heat from a flame front that moves over a fire shelter. A blend of any of the fibers described herein may be included in the insulating fabric layer, or a layer of the insulating fabric layer. The fibers may be long having a length to diameter ratio of about 50:1 or more, 100:1 or more or even 1000:1 or more, as in nearly continuous in length while remaining constant in diameter. The fibers may have a denier of about 20 or less, about 10 or less, about 5 or less, about 2 or less, about 1 or less. The lower the denier, the higher the surface area which may aid in scattering the heat and also polarizing the radiant energy.

The insulating fabric layer may include one or more layers of oriented high temperature fibers that include fibers that are aligned with each other, parallel along the length of the fibers and having a spacing or gap therebetween. The aligned oriented high temperature fibers may have a spacing between the aligned or oriented fibers of about 20 μm or less, about 15 μm or less, about 10 μm or less, about 7.5 μm or less, about 5 μm or less about 2.5 μm or less, about 1 μm or less, about 0.75 μm or less, about 5 μm or less or even about 0.4 μm or less such as from about 0.4 to about 15 μm. This range of wavelengths covers the range from visible light through long wave infrared. This is the range of wavelength that would be responsible for producing heat when incident on a surface and therefore, this range is a specific range to be polarized, wherein much of the radiation in this wavelength would be blocked. Generally, the closer the spacing is to the wavelength of the incident radiation, the better the polarizing effect may be on blocking heat. Also, an insulating fabric layer may include a plurality of oriented high temperature fiber layers that are configured at offset angles to each other, or orthogonally to each other. A first layer of insulating fabric layer may include oriented high temperature fibers that are oriented substantially orthogonally to a second and adjacent layer of oriented high temperature fibers, within about 20 degrees of orthogonality.

Also, a first layer and second layer may have different spacing between the aligned or oriented fibers to account for temperature changes through the thickness of the flexible polarizing heat barrier. A first layer, configured more proximal to the exposure side may have a smaller spacing between fibers than a second layer configured more proximal to the shield side. The second layer spacing between oriented fibers may be greater by about 20% or more, 50% or more, 100% or more, 200% or more than the spacing between the oriented fibers of the first layer. Also, a first layer of oriented fibers in the insulating fabric layer may have a smaller fiber diameter than a fiber diameter of a second layer of oriented fibers in the insulating fabric layer. The diameter of the fibers in the second layer may be greater, by about 20% or more, 50% or more, 100% or more, than the fiber diameter of the fibers in the first layer or oriented fibers in the insulating fabric layer; the first layer may be orthogonal to the second layer. The changes in spacing and size may more effectively reduce radiation and resultant heat flux through the flexible polarizing heat barrier.

Additionally, the layers of oriented fibers may have another material used a separator between the layers, such as a gas barrier to reduce advection through the system, or an insulation.

An insulating fabric layer may have a polarizing fabric layer that incorporates oriented fibers, aligned in parallel to produce elongated gaps between the oriented fibers with a spacing between the oriented fibers configured to polarize radiant heat. The spacing between the oriented fibers may be about 5 μm or less, about 4 μm or less, About 2 μm or less, about 0.2 μm or more, about 0.4 μm or more, about 0.5 μm or more, and any range between and including the spacing values provided, such as from about 0.4 μm to about 5 μm.

The polarizing fabric layer may have a fiber density and/or elongated gap density measured orthogonal to the orientation direction of the oriented fibers, the number of fibers or number of elongated gaps over a length of 1 mm, of about 50/mm or more, about 75/mm or more, about 100/mm or more, about 200/mm or more, about 300/mm or more, about 500/mm or more, about 750/mm or more, about 1,000/mm or more, such as from about 50/mm to about 500/mm, or about 50/mm to about 750/mm or from 50/mm to about 1,000/mm. For example, if the fibers have a diameter or maximum cross-length dimension of 4.5 microns and the spacing between them is 0.5 microns, then the fiber and spacing density is about 200/mm. If however, the fibers are smaller with a diameter or maximum cross-length dimension of about 2 microns and the elongated gaps have a spacing of 0.5 microns, then the fiber and spacing density is about 400/mm. A higher fiber density and spacing density may more effectively polarize the light.

The spacing between the oriented fibers may be controlled by a coating, wherein the coating thickness sets the spacing between the fibers. The spacing between fibers may be the coating thickness between fibers or the sum of the coating thickness of each of adjacent fibers. The coating may be any suitable coating and may be continuous around the fibers.

Polarizing layer may be bonded or coupled to a scrim or fabric such as a woven or non-woven to maintain the orientation and spacing between the fibers of the polarizing fabric layer.

Others spacing methods for controlling the elongated gaps or spacing between the oriented fibers of the polarizing fabric layer include fiber crimping, methods of bonding the fibers to a foil or scrim, which may be selected to participate or not participate optically in the system, or methods of creating shards or nodules along the fiber length to ensure proper spacing. Alternatively, the fibers could be embedded in a rigid or flexible system designed to ensure their proper spacing. In the case of some materials, for example silicon carbide, the fibers could be heat treated such that a thin layer of silica forms on the outside of the fiber, and the transparent layer of silica would ensure the proper spacing. In another example, PAN-derived carbon fibers could be intersticed with optically transparent silica fibers, and the entire tow of oriented fibers used to construct the layer of oriented fibers. The fibers could be fluted in the longitudinal direction, or spiral. Alternatively, the fibers could have an overwrap of an optically transparent nanofiber that would provide spacing control.

Additionally, combining different fibers with different spacings in the first layer may be an effective means of mitigating heat transfer through a barrier in an application with multiple peak heat loads. For example, a maneuverable hypersonic vehicle would have multiple peak heating loads with each maneuver and might also have a higher peak heating loading during its final re-entry. Maneuvering heat loads would likely be characterized by short, high temperature pulses of heat characterized by a specific wavelength of infrared energy, while the longer duration re-entry segment would be characterized by a longer duration pulse. Because it is also common in fire shelters and hypersonic vehicles for the outer layer of the Thermal Protection System (TPS) to degrade, these systems could be designed such that the fibers and their spacing as used in the outermost layer of the TPS, nearest the heat source, is designed to mitigate heat transfer anticipated during the early stages of the application, and the fibers and their spacing in in the interior layers are exposed through ablation and are optimized to mitigate heat flux through the system expected later in the mission. Multiple layers of cascading designs could be incorporated into the TPS. Selecting the fiber material, diameter and spacing, and combing those fibers in the outermost element of the barrier could be an effective means of reducing the overall heating.

Additionally, optimizing a TPS for a specific mission could take advantage of various optical mechanisms controlled by proper selection of the fiber material, diameter and spacing. The three optical mechanisms controlled by these selections are back scatter (i.e. reflection), transmission and re-emission. Reflection describes the energy that is not absorbed or transmitted by the layer of fibers. It constitutes the energy that bounces off the surface and the energy that is absorbed and re-emitted from the front surface toward heat source. Infrared energy that passes between the fibers, as polarized IR waves constitute the transmitted component of energy. Energy that is absorbed by the fibers and re-emitted at the same or a longer wavelength comprise the re-emitted component of the total heat flux. Moving through the layers of the system, those same mechanisms may be manipulated by selection of material, diameter and spacing. In complex systems, this is best done by computer model. An output of such a model is provided herein.

The optical properties of the fibers could be further manipulated by treating those fibers such that the re-emission of heat from the fibers is inhibited on the side of the fibers away from the heat source, and enhanced on the side of the fibers facing toward the heat source. Generally, the methods of optical manipulation known as total internal reflection could also be applied to the invention described here. These can be applied to the fibers, through the use of surface treatments, or the spacing systems described earlier. It would also be possible in an optimized fibrous system to optimize the shape of the fiber. Taking the concept of the fluted fiber, which was mentioned previously, it would further be possible to use flutes to create facets in the fibers with optimized optical properties, such that the surface pointed outward was shaped and treated to maximize reflection and re-emission of heat flux, while the inward facing facets and curves of the fibers were treated and spaced to reduce heat flux passing through the TPS.

Furthermore, redirecting the heat through the use of this invention, configured now as described above and intended to function as a lens, could be beneficial for example in redirecting heat from the leading edge or control surface of a hypersonic vehicle. As this is sometimes done with heat pipes or active cooling systems, this passive method of directing heat away from high heat area would offer a more reliable, less expensive solution. This would be achieved by properly selecting the fiber material, spacing mechanism, treatments and dimensions, and treating the TPS as an optical system in computer modeling methods to optimize the solution.

TABLE 1

| | | Max | | | | | | |
|---|---|---|---|---|---|---|---|---|
| | Estimated | Processing | | | | Mechanical | | |
| | Material | Temperature | Density | Density | Stength, | Resistance | cm2 of | |
| | Cost | C. | g/cm3 | g/cm3 | Mpa | cm2/N | material | g/m2 |
| Innegra | | 150 | 0.84 | 0.49 | 667 | 1.49E−05 | 1.096 | 39.67 |
| S-glass | $3.00 | 850 | 2.48 | 1.43 | 4750 | 2.10E−06 | 0.0013 | 16.44 |
| E-glass | $3.00 | 730 | 2.54 | 1.47 | 2600 | 3.84E−06 | 0.0026 | 30.75 |
| carbon | $15.00 | 3500 | 1.76 | 1.02 | 3530 | 2.82E−06 | 0.0019 | 15.7 |
| basalt | $14.89 | 980 | 2.7 | 1.56 | 4840 | 2.06E−06 | 0.0013 | 17.56 |
| baseline | $14.29 | 204 | 1.55 | 0.9 | 400 | 2.49E−05 | 0.018 | 122.03 |
| cotton | | | | | | | | |
| scrim | | | | | | | | |
| aramid | $164 | 450 | 1.44 | 0.83 | 2400 | 4.26E−06 | 0.0032 | 18.89 |
| quartz | $300 | 1070 | 2.2 | 1.27 | 6000 | 1.67E−0.6 | 0.0013 | 11.56 |
| 3M | $300 | 1200 | 2.8 | 1.62 | 1630 | 6.13E−06 | 0.0045 | 54.08 |
| Nextel | | | | | | | | |
| 312 | | | | | | | | |
| silicon | $6,000 | 1650 | 3.1 | 1.79 | 1625 | 6.15E−06 | 0.0045 | 60.08 |
| carbide | | | | | | | | |

This is for just a uni-direction layer. Calclate each ply separately and add weights.

The insulating fabric layer may form a fibrous mat that may be either woven or nonwoven, and the materials of construction may be chosen to best suit the end application by comparing material properties as shown in Table 1. A typical application will consider the maximum processing temperature capability of the material and the cost. Some applications may also need to consider strength. Fire shelters for example must endure extreme winds accelerated by the approaching fire and have typically required fabrics with a tensile strength of at least 157N/cm (90 lbf/in) or more, or about 210N/cm (120 lbf/in), like Style 1080 fiberglass fabric from JPS Composite Materials (Anderson SC). The insulating fabric layer or the flexible polarizing heat barrier may meet a burst strength requirement as detailed in USDA Forest Service Specification 5100-607D, which specifies (p.6) an average burst strength, for 3 specimens, of not less than 482 kPa (70 psi) when tested per ASTM D 774 and Paragraph 4.4.2.7 of the USDA specification. The insulating fabric layer may consist of woven fibers, unidirectional fibers or randomly oriented fibers depending on the needs of thermal and mechanical properties and the requirements of the coating. The amount of vermiculite, PCM's, opacifier, intumescent can be interspersed between the fibers, dependent on construction method. Nonwovens have a very high porosity or void volume, such as about 90% or more, therefore there is plenty of volume for other components of the flexible polarizing heat barrier. Woven and unidirectional arrays have less porosity and therefore there is less space for coating.

### FOIL

An exemplary foil is configured as an inner layer or shield side of the flexible polarizing heat barrier or fire shelter and is configured to prevent gases from entering the shelter and to reflect radiant energy away from the interior of the fire shelter. An exemplary metal foil has low emittance values and high temperature resistance. A metal foil may be any suitable type of metal including but not limited to, aluminum, copper, gold, platinum, titanium, nickel and iridium. The metal foil may be thin to reduce the weight of the fire shelter and may have a thickness of no more than about 35 μm, no more than about 30 μm and even more preferably less 25 μm, such as about 15 μm or less. A thin metal foil layer is preferred as it reduces weight and bulk of the lightweight multilayer flame barrier. The foil may have an effective low emittance to reduce radiant heat effects. Bare aluminum foil has an emittance of 0.03 μm to 0.05 μm over the IR Wavelength range of wavelengths representing peak radiation for the temperatures of interest. Gold foil has a lower emittance, and withstands higher temperatures but cost limits its applications. Copper foil has low emittance but it oxidizes so readily that its use may be limited to nonoxidizing environments. Although the emittance of titanium foil, which is 0.63, is not outstanding, it could be advantageous if, for example, the fibrous mat was Nextel 440, which has an emittance of 0.87, measured at 25° C. The titanium foil would reduce the radiant heat transfer while offering greater temperature capability of 3000° F. compared to that of aluminum foil of 1220° F. Applying a gold coating by physical vapor deposition to a base lower cost foil, such as titanium foil would provide low emittance of approximately 0.02 at a relatively low cost. Therefore, an exemplary foil includes titanium foil with a lightweight layer of gold attached to the titanium foil, such as by vapor deposition.

The foil may be attached to the fabric layer by an adhesive or by a physical bond, such as by stitching. The adhesive may be a high temperature adhesive such as silicone. The metal foil may be attached to fabric layer with an adhesive that may be a continuous layer or discrete adhesive application, such as adhesive dots. An adhesive may be a fluid that is applied to one or more of the foil and fabric layers being attached. An exemplary adhesive comprises silicone and may be a condensation cured silicone, acetoxy cured silicone, platinum catalyzed cured silicone or a peroxide cured silicone. An adhesive may be diluted with water or solvent prior to application to the lightweight multilayer flame barrier. Also, adhesives with an acceptable decomposition profile, such as poly vinyl acetate, may be considered. Alternatively, the foil may be formed on the fabric by metal spraying with the advantage that adhesives and stitching are eliminated.

### COATING OUTER LAYER

An exemplary flexible polarizing heat barrier comprises a coating or coating layer coupled to the insulating fabric layer and forming an exposure side of the flexible polarizing heat barrier. The coating may reduce permeability, provide heat capacitance and may scatter or reflect heat from the flexible polarizing heat barrier. The coating may have a gas barrier component that reduces the permeability through the coating layer and therefore through the rest of the flexible polarizing heat barrier. The coating may have an intumescent component, a component that expands or swells with application of heat to protect the underlayers of the flexible polarizing heat barrier. The coating may have an opacifier component that is configured to scatter radiant energy. The coating may have a heat capacitance component such that the ingredients are optimized for maximum heat capacitance to further delay heat flux or minimized to not retain heat as required by the application. A mixture of these components may be held together by a binder and this binder may couple the coating to the insulating fabric layer.

An exemplary gas barrier component may include a planar of flake type of high temperature material, such as vermiculite. The planar geometry of the vermiculite may effectively reduce the air permeability through the flexible polarizing heat barrier. A concentration of the gas barrier component may be used to provide a percentage coverage of the gas barrier component. The gas barrier component may therefore be included in the coating in a weight concentration of about 50% or more, 50% or more or even 75% or more. Vermiculite may be included in the coating in a concentration of about 0.5 g/m², for example and this may form a layer of vermiculite that is about 0.5 μm thick. Note that the concentration may be about 0.5 g/m2 or more, about 0.7 g/m2 or more or even about 1.0 g/m2 or more to provide more permeability reduction from an increased thickness and/or greater coverage of the vermiculite.

In addition, the vermiculite solution serves to suspend the opacifier component and the intumescent component during application without compromising their performance on exposure to fire. An exemplary vermiculite solution is Microlite HTS Vermiculite dispersion from Specialty Vermiculite Corp. of Enoree SC.

An exemplary coating layer may include an intumescent component, a component that expands with application of heat to protect the underlayers of the flexible polarizing heat barrier. An exemplary intumescent component is expandable graphite which may be included in a concentration of about 50% or more by weight of the coating. Expandable graphite may be incorporated into the coating because it intumesces endothermically. Not only does it expand, thereby increasing the gap between adjacent materials and the middle layer, but the molecular bonds of the water in the carbon absorb energy as the water is released as steam. The exemplary intumescent component used in the coating described herein is available from Asbury Carbons (Asbury NJ), and have the product code Grade 3626.

The coating may have an opacifier component that is configured to scatter radiant energy. An exemplary opacifier may include high temperature fibers such as silicon carbide fibers. The fibers may have a diameter that is very small such that they are substantially the diameter, within about 50% of the radiant energy wavelength, such as about 10 μm or less, about 8 μm or less, about 5 μm or less, about 3 μm or less, about 2 μm or less, about 1 μm or less or even 0.5 μm or less. The size of the silicon carbide fibers may be selected for an application wherein the wavelength of radiation is predicted. Silicon carbide whiskers may provide increased thermal mass without significantly increasing thickness, as well as the capability to reduce radiative heat transfer by optical properties. An exemplary opacifier is C-Tuff SFC Microfibers from Haydale Ceramic Technologies LLC of Greer SC.

The coating may include a binder to hold the components together and this coating may include silicone or another polymeric binder.

For a given application the fabric and foil elements may be chosen first as they determine the minimum areal weight and thickness. For example, in the Example described in Table 2, the fiberglass cloth and foil combination provide the minimal strength and the foil layer on the shield side for reduced emittance, and have a combined thickness of 0.0762 mm (0.003 in) and a weight of 118 g/m² (3.5 oz/yd²). For this specific application, the maximum thickness is 0.228 mm (0.009 in) and maximum weight is 186 g/m² (5.5 oz/yd²). To this foil/fiberglass laminate is added the coating. The coating is optimized to utilize the remaining allowable weight of 67.8 g/m² (2.0 oz/yd²) and thickness 0.1523 mm (0.006 in) to maximize the efficacy of the Flexible polarizing heat barrier for this application. For practical reasons in developing the coating, one may start with a preprepared high temperature coating such as the vermiculite coating described above. To this are added the phase change materials, intumescent and opacifiers, in the weights and volumes optimized to maximize performance without exceeding the overall allowance for that layer. Furthermore, these components may be selected for their heat capacitance, in other words if 2 opacifier candidates are available, heat capacitance may be the means by which the opacifier is chosen for a given application. The resulting coating is then applied by known methods, which include spraying, troweling, or by doctor blade, among others.

### FLEXIBLE POLARIZING HEAT BARRIER CONSTRUCTION

An exemplary flexible polarizing heat barrier has a construction as detailed in Table 2 below:

| | | Thickness | Weight |
|---|---|---|---|
| Component | Description | mm | g/m2 |
| Coating | vermiculite/SiC/exp. | 0.1524 | 67.81 |
| | Graphite | | |
| | (50:25:25& binder) | | |
| Fabric | fiberglass, Stylle | 0.0508 | 46.79 |
| | 1080 | | |
| Adhesive | foil/cloth bond | 0.0076 | 23.73 |
| Foil | aluminum foil | 0.0178 | 48.15 |
| Total | | 2.286 | 186.48 |

The weight of this flexible polarizing heat barrier is only 186 g/m².

### FLEXIBLE GAS BARRIER

A flexible gas barrier as described in U.S. provisional patent application No. 63/298,168, and to U.S. patent application Ser. No. 17/572,619 and 17/916,794, all to Miller, the entirety of each are hereby incorporated by reference herein, may be used in conjunction with the flexible polarizing heat barrier described herein for fire shelter applications. The flexible gas barrier (FGB) may provide additional survival time in a fire shelter application but would increase the weight of the fire shelter. An exemplary FGB includes a phase-change material (PCM) and optionally vermiculite in a fibrous matrix, wherein the materials are optimized to reduce the heat flux through the layer. The FGB incorporates two mechanisms to reduce heat flux. The first mechanism is absorption of heat by the PCM or frits, wherein the heat is absorbed as a heat of melting. The second mechanism is reduction of advection or heat flow through the flexible polarizing heat barrier. The frits may flow into open spaces of the of the FGB or an adjacent layer to reduce porosity, thereby reducing permeability.

A frit is a ceramic material composition that has been fused, quenched and granulated. Frits may be pulverized pyrometric cone material or pyrometric particles that are coated onto vermiculite to form a FGB layer and may also be incorporated into one or more of the other layers in the flexible polarizing heat barrier. Frits or a FGB may be configured between layers of the flexible polarizing heat barrier, such as between the coating layer and the insulating fabric, and/or between the insulating fabric and the metal foil. Frits absorb heat as they change from solid to liquid and are selected for the temperature at which they change phase to best reduce overall heat flux by mathematical modeling and experimentation. It may be advantageous to use frits with different melt temperatures in a single layer or to provide a construction consisting of more than one flexible gas barrier layer wherein different layers use different frits and the overall construction is optimized, through modeling and experimentation, to reduce overall heat flux through the flexible gas barrier. After the frits absorb heat and melt, the liquid ceramic flows and to reduce permeability through the flexible gas barrier layer or adjacent layers and may form a seal by spanning any gaps between fibers. This seal reduces or prevents heat flow through the flexible gas barrier and further reduces heat flux.

The flexible gas barrier may be configured with the coating or coating layer on or proximal to the exposure side of the flexible polarizing heat barrier. The flexible gas barrier may be a coating on the vermiculite in the coating layer and as the frits melt the intumescent layer expands, it may press the liquid of the melted frits into the openings between the vermiculite. The flexible gas barrier may be within or part of the insulating fabric layer, which is a structural layer of the flexible polarizing heat barrier. The flexible gas barrier may just be frits that form a coating, and these frits may be combined with fluxes and may be combined with fibers or vermiculite

A frit is a ceramic composition that has been fused, quenched, and granulated. A blue frit includes quartz, lime, a copper compound, and an alkali flux, all heated to a temperature between 850 and 1000° C. Quartz sand may be included in blue frits to contribute silica to the frit. Blue frit includes cuprorivaite (CaCuSi₄O₁₀) crystals and partially reacted quartz particles bonded together by interstitial glass. A green frit is copper-wollastonite ([Ca,Cu]₃Si₃O₉) crystals and a “glassy phase rich in copper, sodium, and potassium chlorides”

A frit may include flux, usually oxides, to lower the high melting point of the main glass forming constituents, usually silica and alumina. A ceramic flux, such as those shown in Table 3, functions by promoting partial or complete liquefaction. The most commonly used fluxing oxides in a ceramic glaze contain lead, sodium, potassium, lithium, calcium, magnesium, barium, zinc, strontium, and/or manganese. Some oxides, such as calcium oxide, flux significantly only at high temperature. Lead oxide is the traditional low temperature flux used for crystal glass, but it is now avoided because it is toxic even in small quantities. It is being replaced by other substances, especially boron and zinc oxides.

TABLE 3
Flux

Al2O3
B2O3
BaO
CaO
CO2
CoO
Cr2O3
Cu2O
CuO
Fe2O3
FeO
H2O
K2O
Li2O
MgO
MnO
MnO2
Na2O
NiO
P2O5
PbO
SiO2
SnO2
SO3
SO4
SrO
TiO2
V2O5
ZnO
ZrO
ZrO2

Ultra-high-temperature ceramics (UHTCs) shown in TABLE 4, may be incorporated as a fiber in the insulating fabric layer or opacifier in the FGB and are a class of refractory ceramics that offer excellent stability at temperatures exceeding 2,000° C. UHTCs may include or consists of borides, carbides, nitrides, and oxides of early transition metals, and heavy, early transition metal borides such as hafnium diboride (HfB₂) and zirconium diboride (ZrB₂), or hafnium nitride (HfN), zirconium nitride (ZrN), titanium carbide (TIC), titanium nitride (TiN), thorium dioxide (ThO₂), tantalum carbide (TaC) and their associated composites.

TABLE 4
Ultra-high Temperature Ceramics

| | | | Lattice | | | | | |
|---|---|---|---|---|---|---|---|---|
| | | | parameters | | | | | |
| | | Crystal | (Å) | | | Density | Melting point | |
| Material | Formula | structure | a | b | c | (g/cm3) | (° C.) | (º F.) |
| Hafnium carbide | HfC | FCC | 4.638 | 4.638 | 4.638 | 12.76 | 3958 | 7156 |
| Tantalum carbide | TaC | Cubic | 4.455 | 4.455 | 4.455 | 14.5 | 3768 | 6814 |
| Niobium carbide | NbC | Cubic | — | — | — | 7.82 | 3490 | — |
| Zirconium carbide | ZrC | Cubic | 4.693 | 4.693 | 4.693 | 6.56 | 3400 | 6152 |
| Hafnium nitride | HfN | FCC | 4.525 | 4.525 | 4.525 | 13.9 | 3385 | 6125 |
| Hafnium boride | HfB2 | Hexagonal | 3.142 | — | 3.476 | 11.19 | 3380 | 6116 |
| Zirconium boride | ZrB2 | Hexagonal | 3.169 | — | 3.53 | 6.1 | 3245 | 5873 |
| Titanium boride | TiB2 | Hexagonal | 3.03 | — | 3.23 | 4.52 | 3225 | 5837 |
| Titanium carbide | TiC | Cubic | 4.327 | 4.327 | 4.327 | 4.94 | 3100 | 5612 |
| Niobium boride | NbB2 | Hexagonal | 3.085 | — | 3.311 | 6.97 | 3050 | 0 |
| Tantalum boride | TaB2 | Hexagonal | 3.098 | — | 3.227 | 12.54 | 3040 | 5504 |
| Titanium nitride | TiN | FCC | 4.242 | 4.242 | 4.242 | 5.39 | 2950 | 5342 |
| Zirconium nitride | ZrN | FCC | 4.578 | 4.578 | 4.578 | 7.29 | 2950 | 5342 |
| Silicon carbide | SiC | Polymorphic | — | Various | — | 3.21 | 2545 | 4613 |
| Vanadium carbide | VC | Cubic | — | — | — | 5.77 | 2,810 unstable | — |
| Tantalum nitride | TaN | Cubic | 4.33 | 4.33 | 4.33 | 14.3 | 2700 | 4892 |
| Niobium nitride | NbN | Cubic | — | — | — | 8.47 | 2573 | — |
| Vanadium nitride | VN | Cubic | — | — | — | 6.13 | 2,050 unstable ? | — |

A flexible gas barrier (FGB) may include a vermiculite layer to reduce advection more quickly. Based on experiments, it takes a few seconds for the PCM's to melt, flow and seal. By incorporating vermiculite into the FGB, advection can be temporarily reduced in the FGB from the beginning of the exposure. When vermiculite is added to the FGB, a solution may be formed as taught by U.S. Pat. No. 3,325,340 to G. Walker during the FGB manufacture to form a barrier against advection which is effective from the initial exposure. By blocking advection, heat is retained within the FGB, and this accelerates the phase change of the PCM's enhancing overall performance. These FGB's are intended for moderate and high temperatures where ceramics can be used as PCM's. Fibers of fiberglass, silica, mullite, alumina, silicon carbide, or others listed in Table 4 could be used to form a substrate for the FGB, wherein the fibers may be woven, unidirectional or randomly oriented as in a nonwoven. A binder could be added to hold the FGB materials in a layer form until exposure. FGB thickness could be 0.1 mm to 5 mm. The FGB could be made by producing a slurry which could be cast and made into a free-standing layer or applied to a substrate.

The summary of the invention is provided as a general introduction to some of the embodiments of the invention, and is not intended to be limiting. Additional example embodiments including variations and alternative configurations of the invention are provided herein.

### BRIEF DESCRIPTION OF SEVERAL VIEWS OF THE DRAWINGS

The accompanying drawings are included to provide a further understanding of the invention and are incorporated in and constitute a part of this specification, illustrate embodiments of the invention, and together with the description serve to explain the principles of the invention.

FIG. 1 shows a perspective top view of a fire shelter.

FIG. 2 shows several prototype fire shelters evaluated during development of the M2002

FIG. 3 shows a graph of Temperature And Heat Flux Comparison, With And Without FGB.

FIG. 4 shows a diagram of the layers of an exemplary fire shelter, lay-up #2, compared with two other lay-ups, including the M2002 fire shelter and another experimental lay-up, Lay-up #1.

FIG. 5 shows the Meker Burner test results for duration for the fire shelter lay-ups depicted in FIG. 4.

FIG. 6 shows a graph of Meker burner results for two fire shelter lay-ups containing an FGB that offer significantly improved habitability compared to the M2002, for which data is also plotted.

FIG. 7 shows a cross-sectional diagraph of an exemplary middle layer having a fabric configured between and integrally coupled to a coating on the hot side, and a foil on the cold side.

FIG. 8 shows a prospective view of an exemplary insulating fabric layer having layers of oriented fibers configured orthogonally to each other.

FIG. 9 shows the results of Meker burner tests for three-layer fire shelter systems including a middle layer as depicted in FIG. 8 with the construction as described herein.

FIG. 10 shows photographs of the shield side of the flexible polarizing heat barrier following a Meker burner test.

FIG. 11 shows photographs of the exposure side of the flexible polarizing heat barrier following a Meker burner test.

FIG. 12 shows a graph of emittance values for foil over wavelength of interest for a fire shelter application.

FIG. 13 shows a graphical model of radiant heat transfer through a polarizing fiber array.

FIGS. 14, FIG. 15 and FIG. 16 show a graphical model of the effect of a polarizing fiber array with varying gap distances between the oriented fibers.

FIG. 17 shows a chart of transmittance, reflectance and absorption through a polarizing fiber array.

FIG. 18 shows a diagram of a woven fabric that may be a layer or component of the insulating fabric layer.

FIG. 19 shows a top view of a polarizing fabric layer having a plurality of fibers aligned to produce a plurality of spaces or elongated gaps between the fibers that are sized to match the wavelength of radiation that will be polarized, such as from about 0.4 μm to about 15 μm.

FIG. 20 shows a graph of intensity of radiation versus wavelength and a spike for a blackbody radiation curve in the range of about 0.4 μm to about 4 μm, wherein this range maybe preferred for polarization.

Corresponding reference characters indicate corresponding parts throughout the several views of the figures. The figures represent an illustration of some of the embodiments of the present invention and are not to be construed as limiting the scope of the invention in any m components from one figure may be an included in the other figures. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

### DETAILED DESCRIPTION OF THE ILLUSTRATED EMBODIMENTS

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications, improvements are within the scope of the present invention.

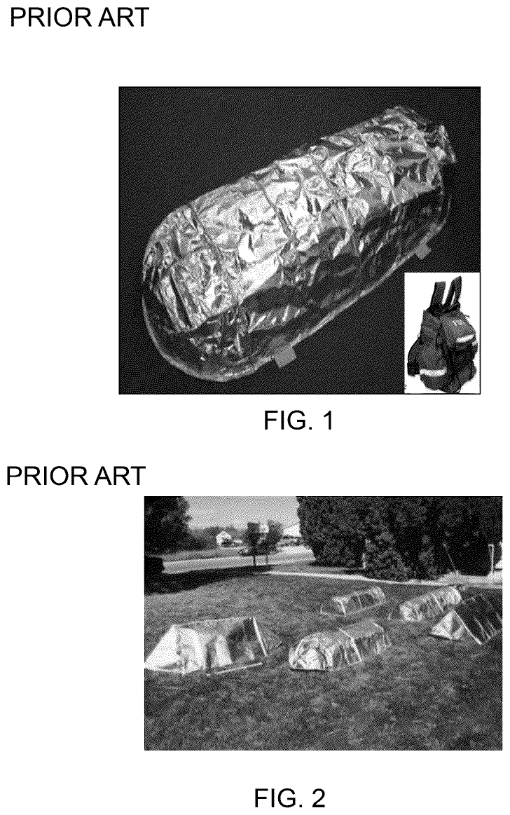

Referring now to FIGS. 1 and 2, a fire shelter forms a top shielding surface or enclosure and is configured to fit into a compact space, such as a backpack. The fire shelter is configured to be folded and configured in the backpack. The image of the backpack is not to scale. As shown in FIG. 2 a plurality of fire shelters can be deployed to form a protective dome over each firefighter in a group.

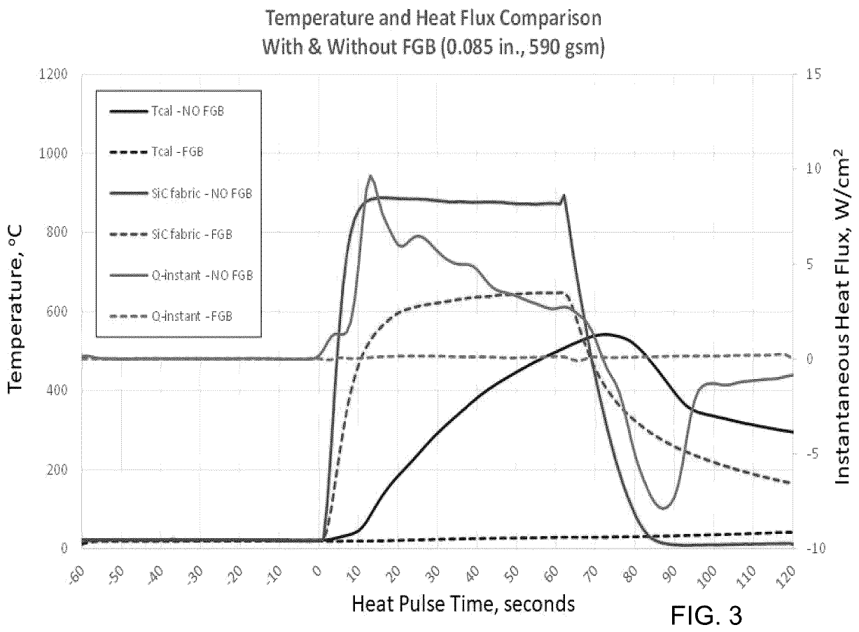

As shown in FIG. 3 instantaneous heat flux in forced convection environment can be greatly reduced by the addition of a Flexible Gas Barrier (FGB) layer. FIG. 3 compares instantaneous heat flux, Qᵢₙₛₜₐₙₜ and temperatures in two locations over a 60 second exposure for insulation systems with and without the FGB. The system with the FGB indicates significantly lower heat flux resulting in significantly lower temperatures at both locations measured.

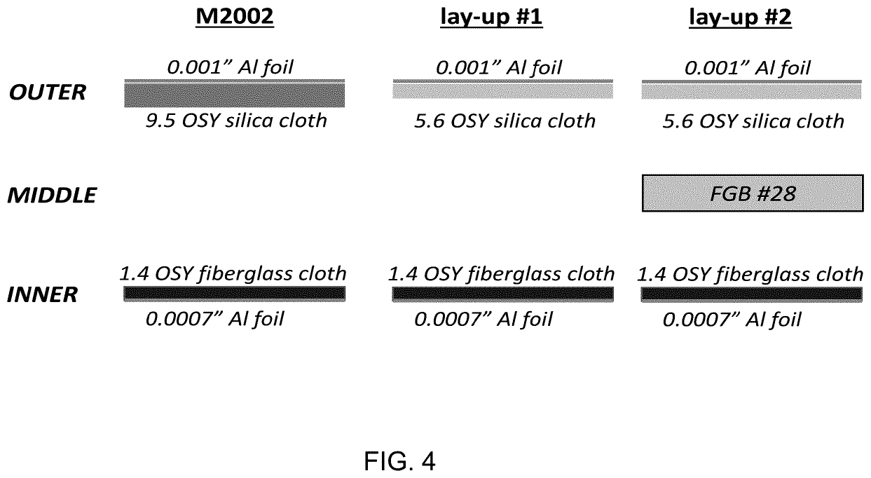

A flexible gas barrier (FGB #28), a ceramic paper with a phase change material including frits and vermiculite, was developed for use as the middle layer in a fire shelter lay-up shown in FIG. 4. flexible polarizing heat barrier

The weights and thicknesses of the materials in the three constructions of FIG. 4 as well as a Phase 1 target are tabulated in Table 5.

TABLE 5

| | | | Lay-up #2 | Phase 1 |
|---|---|---|---|---|
| | M2002 | Lay-up #1 | FGB#28 | Target |
| Outer g/m2 | 434 | 301.8 | 301.8 | 301.8 |
| Middle g/m2 | n.a. | n.a. | 115.3 | 186.5 |
| Inner g/m2 | 94.9 | 94.9 | 94.9 | 94.9 |
| Total Shelter Wall | 528.9 | 396.7 | 512 | 583.2 |
| g/m2 | | | | |
| Floor kg | 0.531 | 0.390 | 0.390 | 0.390 |
| Seams kg | 0.086 | 0.086 | 0.086 | 0.086 |
| Complete Shelter, kg | 1.99 | 1.51 | 1.81 | 1.99 |
| Wall Thickness, mm | 0.762 | 0.584 | 0.914 | 0.991 |

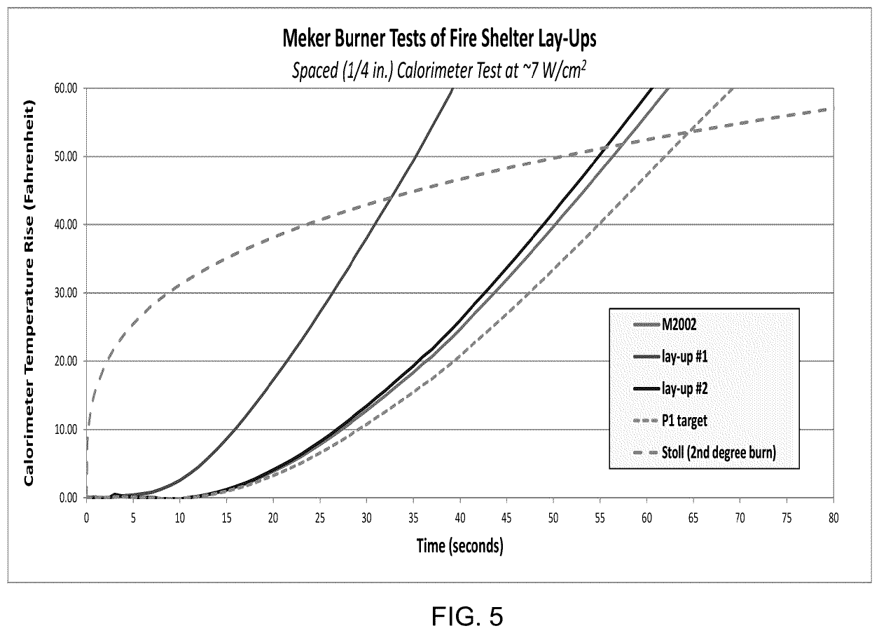

Also, the thermal performance of these constructions was tested and plotted in FIG. 5, where the intersection of the calorimeter temperature data with the Stoll curve predicts the fire shelter failure due to second degree burns on the occupant. As shown from the weights in Table 5 and the Meker burner test results in FIG. 5, increasing wall weight improves performance and delays second degree burns. It can also be seen that the performance of the M2002 was matched by lay-up #2, which is 10% lighter than the M2002. The Flexible Gas Barrier (FGB #28) layer was used as the MIDDLE layer in lay-up #2, and provided equivalent performance to the M2002 construction at a lighter weight.

As shown from the weights of the components in Table 5 and the Meker burner test results in FIG. 5, increasing weight improves performance and delays second degree burns. It can also be seen that the performance of the M2002 was matched by lay-up #2, which is 10% lighter than the M2002. This suggests that an insulating fabric layer that is slightly heavier than FGB #28 can be successfully utilized to increase fire shelter habitability by 20% without increasing overall weight or bulk. In these tests, a Flexible Gas Barrier (FGB) layer was configured between fabric laminates similar to those currently used in the M2002.

The insulating fabric layer may be specifically optimized to increase time to second degree burn, or shelter protection time. In an exemplary embodiment, an improvement of about 20% (˜11 second) over M2002 is realized with no increase in weight or bulk over M2002. This improvement will produce a fire shelter with improved efficacy resulting in fewer injuries and deaths for firefighters and support personnel. The cost of an exemplary fire shelter of the present invention may be maintained to a marginal amount over the cost of the M2022 fire shelter, such as no more than about $100 per shelter, or even no more than $85 per shelter.

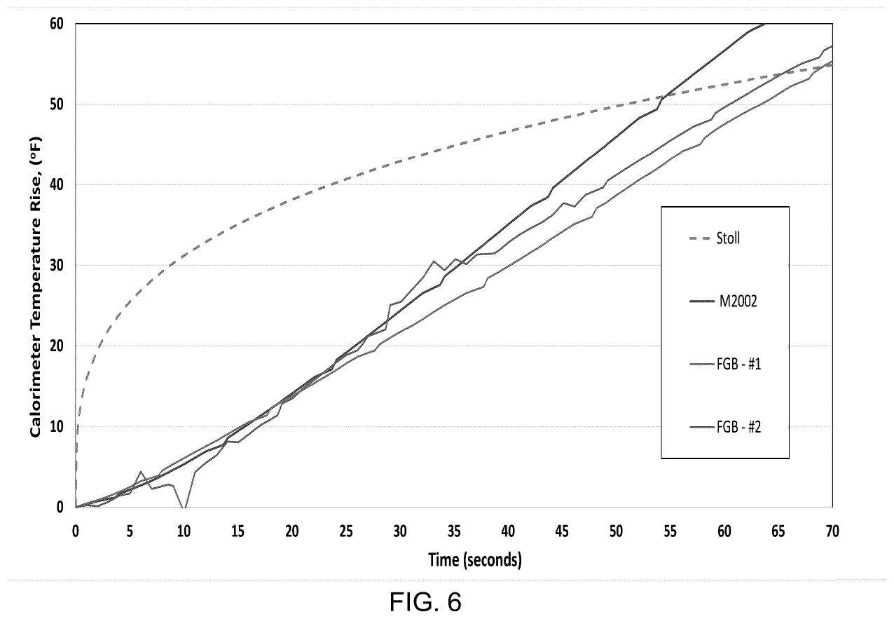

As shown in FIG. 6, research and development further confirmed that a FGB layer that meets the weight and thickness constraints of the proposed fire shelter design and also increased survivability by 20%. The Meker burner test data confirms that the M2002 is survivable for 54 seconds in the controlled test, and the flexible polarizing heat barrier with the FGB configured between the coating and the foil layer increases survivability to 64 seconds, representing a 20% improvement. FGB-#1 and FGB-#2 are plots of data from two separate runs of the same FGB material, meant to indicate the repeatability of the results. Of course, full shelters would need to be constructed and tested to confirm the suitability of other aspects of the design.

An exemplary fire shelter of the present invention meets the following qualifications:
a. Maintain radiant heat protection of the current M2002 fire shelter
b. Improve protection in direct flame contact
c. Maintain the requirement that users not be exposed to dangerous toxic compounds from the shelter
d. Maintain the strength and durability of the current M2002 fire shelter
e. Prevent flammable gasses from collecting inside the fire shelter
f. Maintain the weight and bulk of the current M2002 fire shelter
g. Marginal to no increase in cost over the M2002 fire shelter.

As shown in FIG. 7, an exemplary flexible polarizing heat barrier 30 comprises an insulating fabric layer 60 with a coating 40 configured on an exposure side 24, and a metal foil 80 configured on a shield side 26. As described herein the coating 40 is configured to reduce heat transmittance, while the insulating layer is configured to provide structural support and insulate the shield side from heat and the metal foil is configured to reduce heat radiated from the cold side and provide a gas barrier. The flexible polarizing heat barrier 30 may include a flexible gas barrier 90.

As described herein, the insulating fabric layer may include a polarizing fabric layer 61 that may comprise one or two or more layers of high-temperature oriented fibers 64. The layers may have the oriented fibers oriented orthogonally to each other, such as within about 20 degrees of orthogonal to polarize the radiant energy. A thin layer of optically transparent material, like a nonwoven alumina mat, or woven quartz scrim may be used to thermally isolate the layers of oriented fibers without significantly interfering with the polarization process. An adhesive 50 may be used to bond the metal foil layer to the insulating fabric layer. The coating layer 40 may include a binder 45 that adheres the coating to the insulating fabric layer. Table 2 shows the construction of an exemplary flexible polarizing heat barrier shown in FIG. 7.

The coating 40 includes an intumescent component 42, a gas barrier component 44, such as vermiculite and an opacifier component 46 held together by the binder 45. The ratio of these components may be selected as described herein to provide effective heat shielding properties and survival time.

A flexible gas barrier (FGB) 90 is configured with the flexible polarizing heat barrier 30 and contains a gas barrier 44′, such as vermiculite 94 and pyrometric particles comprising frits 92, fluxes 93 that are configured to melt at prescribed temperature to flow and fill spaces between the gas barrier material. As described herein, the FGB may be a coating configured with one or more of the layers of the flexible polarizing heat barrier or may be a separate layer configured on or between the fibers of the layers, such as between the coating 40 and insulating fabric layer 60 or between the insulating fabric layer and the foil 80.

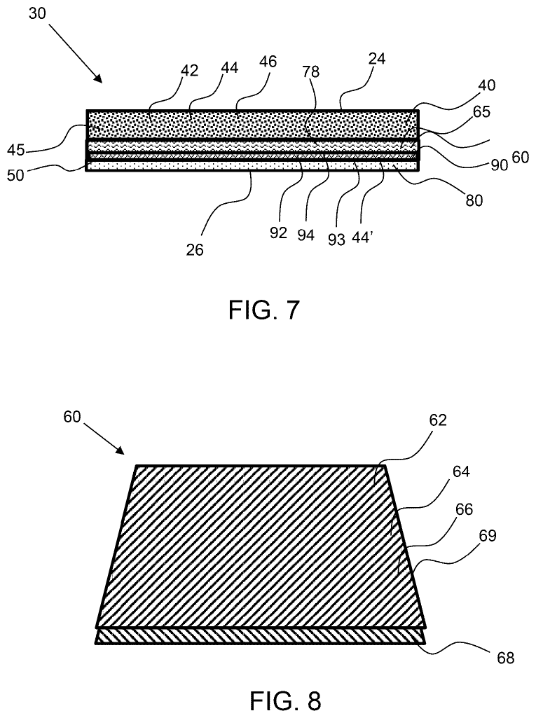

As shown in FIG. 8, an exemplary insulating fabric layer 60 includes a first layer 66 of fibers 62 that are oriented fibers 64 and a second layer 68 with oriented fibers that are configured orthogonally to the oriented fibers in the first layer. As described herein, this arrangement of oriented fibers with a very small elongate gap 69 between the fibers may effectively polarize radiant energy to better insulate the shield side of the flexible polarizing heat barrier. As described herein, the fibers may be small in diameter (maximum cross-length dimension for fibers that are not circular in cross-section), such as about 20 μm or less, about 15 μm or less, about 10 μm or less, about 7.5 μm or less, and preferably about 5 μm or less or more, about 4 μm or less or more about 3 μm or less or more, about 2 μm or more, or from about a 2 μm to about 15 μm, or from about 32 μm to about 15 μm, or from about 4 μm to about 15 μm and any other range between and including the values provided. The spacing or dimension between the oriented fibers, or dimension of the elongated gaps between the parallel or oriented fibers may be substantially the same as the wavelength of the peak radiant energy and may be about the same as the fiber diameters provided.

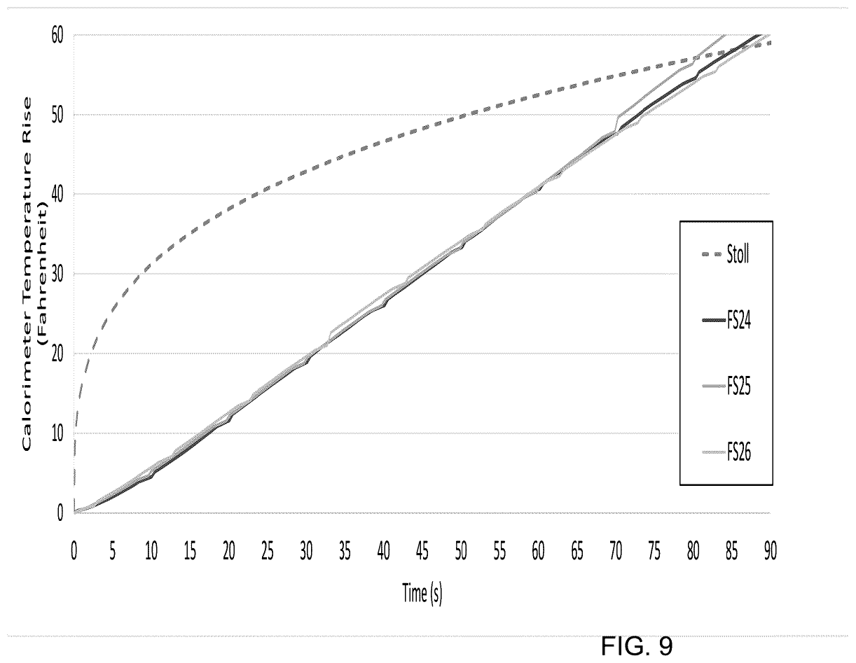

FIG. 9 shows the results of a Meker burner test for three three-layer fire shelter systems with weights and thickness predicted in Table 5 for the Phase I target, and better performance than anticipated in FIG. 5 for the Phase I target. The Meker Burner test shows the intersection of the calorimeter temperature data with a Stoll curve and therefore predicts the fire shelter failure due to 2^{nd} degree burns on the occupant. This lay-up includes the flexible polarizing heat barrier described in Table 2 used in place of FGB #28 in the configuration shown for lay-up #2 in FIG. 4. FIG. 9 shows that each of the flexible polarizing heat barriers tested had a survival time of 86 seconds. The flexible polarizing heat barrier middle layer increases survivability to 86 seconds in the Meker burner test, which represents a 59% improvement over the M2002. The construction of the present flexible polarizing heat barrier for a fire shelter application is expected to be more commercially viable than the technology described in U.S. Pat. No. 10,099,450 because the vermiculite dispersion is not relied upon for adhering the foil to the insulating fabric layer. Lastly, the distinct layers of the flexible polarizing heat barrier each provide a unique benefit, wherein the insulating fabric layer provides added strength, the foil provides a low emittance and the coating absorbs heat while the intumescent component expands with exposure to heat.

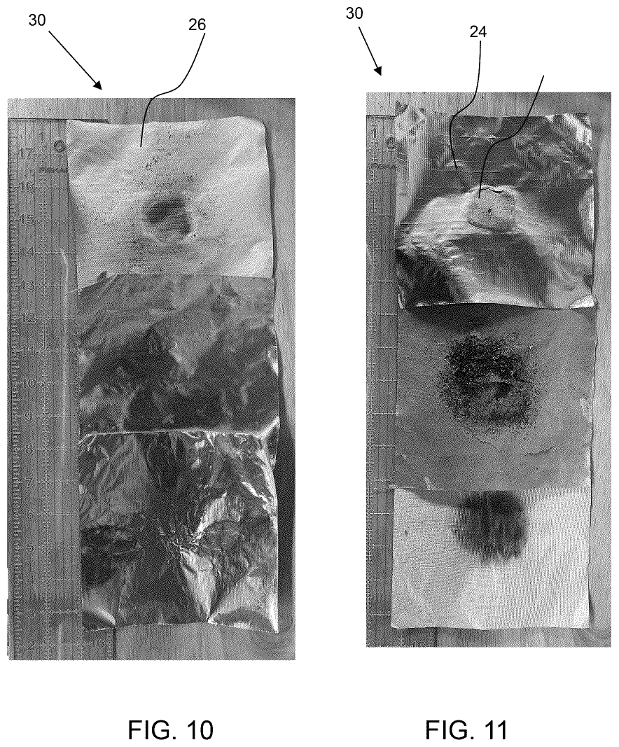

FIGS. 10 and 11 show the fire shelter layers after Meker Burner testing. The exposure side 24 was exposed to the burner during this testing. FIG. 10 shows the shield side of a flexible polarizing heat barrier, the side that would be exposed to the fire fighter in a fire shelter application. As can be seen, it's in good condition even after providing 86 seconds of protection. In FIG. 11, the exposure side shows delamination, as is typical with severe exposures such as this. Also, the intumescent component 42 has intumesced on the exposure side. Since the test only exposes a circular section in the middle of the 15.24 cm square samples, unexposed material, as it would appear in an unused fire shelter, may be seen outside of the central area.

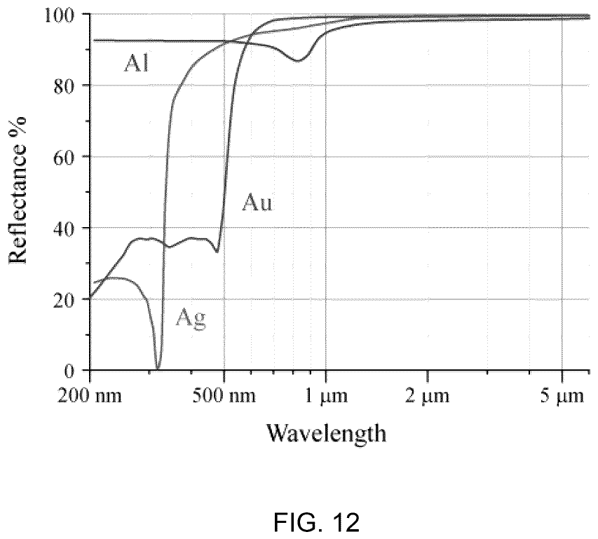

FIG. 12 shows a graph of emittance values for foil over wavelength of interest for a fire shelter application.

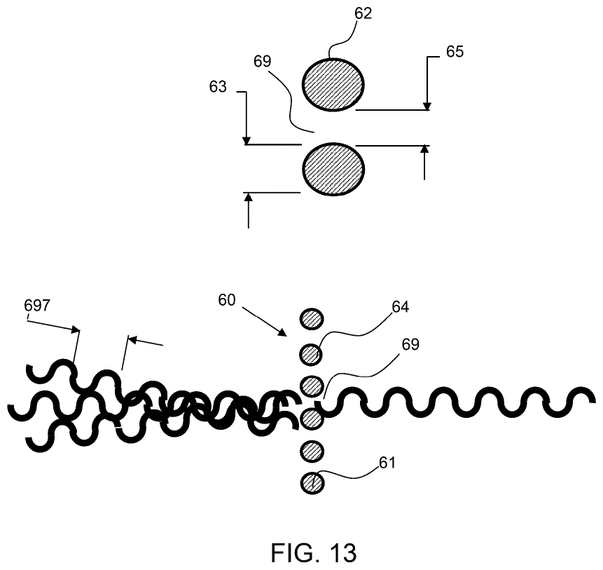

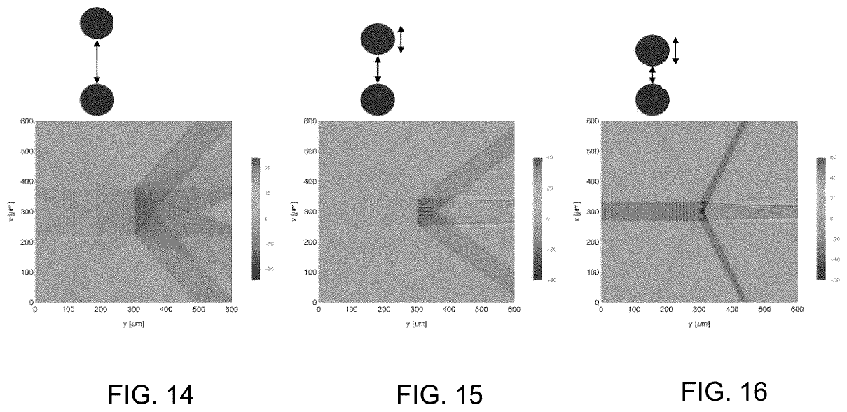

Referring now to FIGS. 13 to 17, an insulating fabric layer 60 with a polarizing array of fibers 62, can effectively polarize radiant energy. As shown in FIG. 13, the fibers 62 in a polarizing fabric layer 61 are oriented fibers 64, aligned substantially parallel with each other (within 20 degrees and preferably within 10 degree or even 5 degrees of each other) and producing elongated gaps 69 with a gap distance 65 between the fibers that may have an average gap distances 65 that approach the wavelength 697 of the radiant energy. When the gap distance is the same or smaller than the wavelength of the radiant energy, the radiant energy will be polarized as it passes through the oriented fibers 64. As shown in FIG. 14 to FIG. 16, the diameter of the fibers and again the gap distance between them will affect the polarization of the light. A gap distance greater than, equal to and smaller than the wavelength of radiation (1 micron) are modeled. The polarizing fabric layer may backscatter the radiant heat or energy to block heat from passing through the heat barrier fabric.

Backscatter is a term used in physics to describe the reflection of waves, particles, or signals back to the direction from which they came. It is usually a diffuse reflection due to scattering, as opposed to specular reflection as from a mirror, although specular backscattering can occur at normal incidence with a surface. In our application and shown in FIGS. 14, 15 and 16, back scatter is denoted with dark blue lines, indicating radiant energy diffusely reflected away from the polarizing heat barrier. Diagram 14 represents a fiber diameter of 0.6 microns and a gap distance of 2.0 microns, greater than the wavelength of the radiation. Diagram 15 represents a fiber diameter of 0.6 microns and a gap distance of 1.0 microns, equal to the wavelength of the radiation. Diagram 16 represents a fiber diameter of 0.6 microns and a gap distance of 0.5 microns, smaller than the wavelength of the radiation.

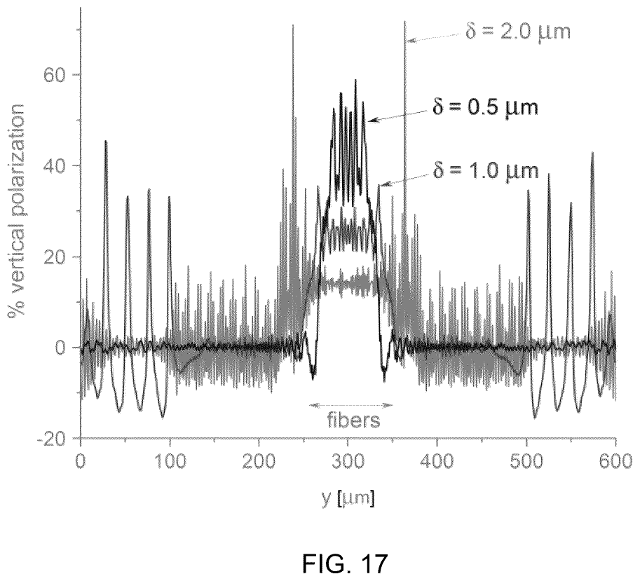

FIG. 17 shows the percent vertical polarization along a line parallel to the fiber-line on the transmitted side of the fibers. The results shows that the fibers do polarize the unpolarized incident radiation. Polarization of the radiation occurs to a greater extend when the gap distance is equal to or smaller than the wavelength of radiation. Polarization of the radiation up to 40 to 50% was predicted for the smallest gap distance spacing of 0.5 μm.

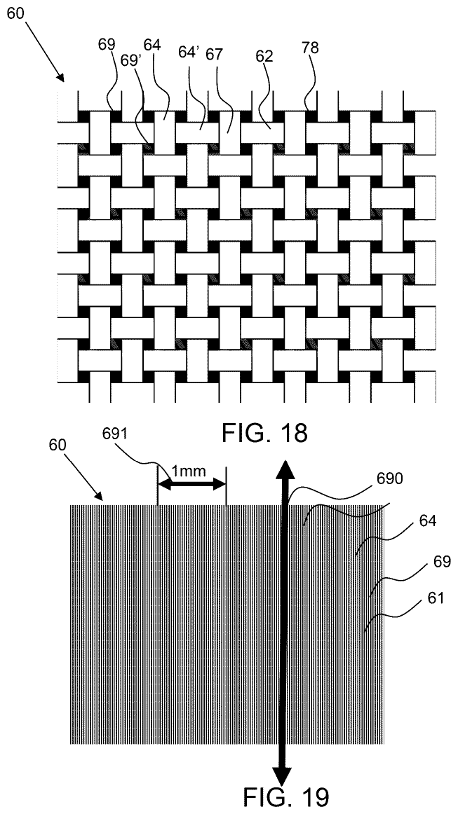

As shown in FIG. 18, a woven fabric 67 may be a layer or component of the insulating fabric layer 60 and may include a first set of oriented fibers 64, and a second set of oriented fibers 64′. The first set of oriented fibers 64 in the weave may be a different type of fiber from the second set of oriented fibers 64′. The woven fabric includes fibers 62 that may be selected from high temperature fibers as described herein, such as polarizing silicon carbide fibers, quartz fibers, glass fibers and the like. The warp fibers may be one type of fiber while the fill fibers or yarns may be a second type of fiber. The oriented fibers produce elongated gaps 69, 69′ between them. The fibers may also include opacifier powders, fibers and/or frits that are powders or fibers and configured to melt and flow to seal off gaps in the weave. The weave may be a plain or basket weave, twill weave, satin weave, or leno weave. A frit fiber may be only a portion of the yarn or strand in the weave. In an exemplary embodiment a first set of fibers or yarns, the warp yarns, comprise polarizing silicon carbide fibers and a second set of fibers or yarns, the weft yarns, comprise optically transparent quartz fibers in a plain, satin, basket, twill or leno weave. The weave and the denier of the weft fibers may be selected to maintain the desired spacing between the polarizing fibers, such as silicon carbide fibers.

A coating 78 may be configured on and/or around the fibers to create the spacing between the fibers. The spacing may be the thickness of the coating between the fibers or the combined thickness of a coating on adjacent fibers. The coating may be continuous around the fibers forming a continuous layer or discontinuous.

As shown in FIG. 19, a polarizing fabric layer 61 of the insulating fabric layer 60 has a plurality of oriented fibers 64 aligned to produce a plurality of elongated gaps 69 between the fibers that are sized to match the wavelength of radiation that will be polarized, such as from about 0.4 μm to about 15 μm and preferably about 0.4 μm to about 4 μm or about 5 μm The orientation axis 690 of the oriented fibers 64 is shown and the fiber and elongated gap density is measure along 1 mm of a density axis 691 that is orthogonal to the orientation axis 690. A microscope may be used to count the number of oriented fibers and/or elongated gaps across the 1 mm or the density axis.

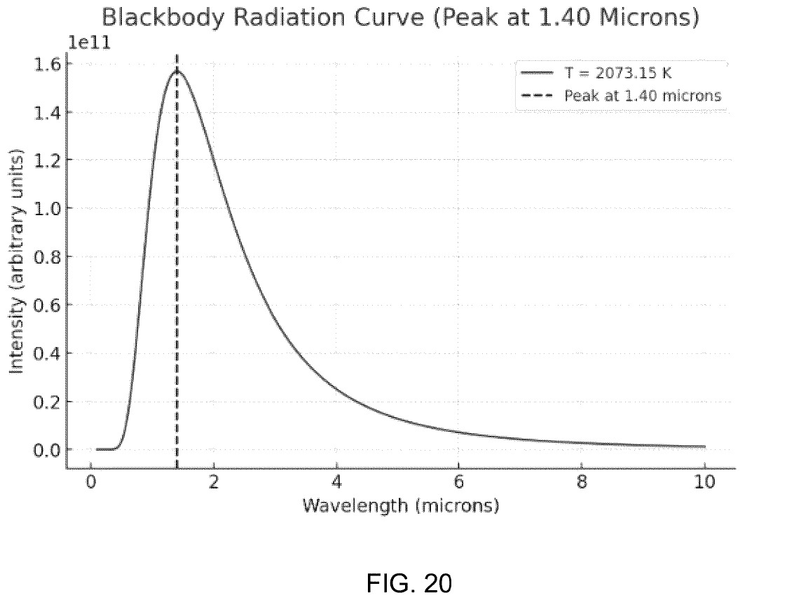

FIG. 20 shows a graph of intensity of radiation versus wavelength and a spike for a blackbody radiation curve in the range of about 0.4 μm to about 4 μm or to about 5 μm, wherein this range maybe preferred for polarization.

It will be apparent to those skilled in the art that various modifications, combinations and variations can be made in the present invention without departing from the scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents.

What is claimed is:

1. A method of blocking heat flux from an exposure side to a shield side of a flexible polarizing heat barrier comprising:
a) providing said flexible polarizing heat barrier comprising:
said exposure side;
said shield side opposite the exposure side;
an insulating fabric layer comprising high temperature fibers having a diameter of 5 μm or less and having a melt temperature of at least 800° C.;
wherein the insulating fabric layer comprises a polarizing fabric layer comprising a first layer of oriented high temperature fibers that are aligned parallel with each other to produce elongated gaps between said oriented high temperature fibers with an average spacing of less than 15 μm that polarizes radiant energy as it passes through said first layer of oriented high temperature fibers;
a coating coupled to said insulating fabric layer and configured on said exposure side of the flexible polarizing heat barrier and comprising:
a binder component;
b) subjecting the exposure side of the flexible polarizing heat barrier to a heat flux including radiant heat;
c) polarizing said radiant heat as it passes through the polarizing fabric layer to block said radiant heat from passing through the flexible polarizing heat barrier from said exposure side to said shield side.

2. The method of claim 1, wherein the average spacing between said oriented fibers is greater than 0.4 μm.

3. The method of claim 2, wherein the average spacing between said oriented fibers is 10.0 μm or less.

4. The method of claim 2, wherein the average spacing between said oriented fibers is 5.0 μm or less.

5. The method of claim 1, wherein polarizing fabric layer has a fiber density and elongated gap density measured orthogonally across the oriented fibers of 50/mm or more.

6. The method of claim 1, wherein polarizing fabric layer has a fiber density and elongated gap density measured orthogonally across the oriented fibers of 200/mm or more.

7. The method of claim 1, wherein the oriented fibers further comprise a coating and wherein the coating forms said spacing between the oriented fibers.

8. The method of claim 1, wherein the polarizing fabric layer comprises a second layer of oriented high temperature fibers that are oriented and aligned parallel and have an average spacing between said oriented high temperature fibers of the second layer of oriented high temperature fibers of 10.0 μm or less.

9. The method of claim 8, wherein the first layer of oriented high temperature fibers are oriented within about 20 degrees or less of orthogonal, to the oriented high temperature fibers of the second layer of oriented high temperature fiber.

10. The method of claim 8, wherein the second layer of oriented high temperature fibers is located more proximal to the shield side and wherein the average spacing between said oriented high temperature fibers of said second layer of oriented high temperature fibers is at least 20% greater than said average spacing between said oriented high temperature fibers of the first layer of said oriented fibers.

11. The method of claim 10, wherein the average fiber diameter of the second layer of oriented high temperature fibers is at least 20% larger than said average fiber diameter of the first layer of said oriented fibers.

12. The method of claim 8, wherein the average fiber diameter of the second layer of oriented high temperature fibers is at least 20% larger than said average fiber diameter of the first layer of said oriented high temperature fibers.

13. The method of claim 8, wherein the first layer of oriented high temperature fibers and second layer of oriented high temperature fibers are woven.

14. The method of claim 1, wherein the insulating fabric layer comprises high temperature polymers having a melt temperature of 300° C. or more.

15. The method of claim 14, wherein the insulating fabric layer comprises polyimide.

16. The method of claim 1, wherein the first layer of said oriented high temperature fibers are inorganic fibers selected from the group consisting of: glass, fiberglass, silicon carbide and mullite, alumina, quartz.

17. The method of claim 1, further comprising a metal foil coupled to said insulating fabric layer and configured on said shield side, opposite the exposure side of the flexible polarizing heat barrier.

18. The method of claim 17, wherein the foil comprises a first layer of foil and second layer of foil, wherein the first layer of foil has an emissivity that is at least 20% higher than an emissivity of said second layer of foil.

19. The method of claim 1, wherein a coating further comprises:
an intumescent component;
an opacifier component; and
a gas barrier component.

20. The method of claim 1, wherein the coating further comprises an intumescent component that comprises expandable graphite.

21. The method of claim 1, wherein the flexible polarizing heat barrier is part of a fire shelter.
